(19) United States
(12) Patent Application Publication
(10) Pub. No.: US 2019/0366807 A1
(43) Pub. Date: Dec. 5, 2019

(54) INTERIOR COMPONENT OF A VEHICLE

(71) Applicant: ILLINOIS TOOL WORKS INC., Glenview, IL (US)

(72) Inventor: Matthias FRISCH, Hof (DE)

(21) Appl. No.: 16/423,540

(22) Filed: May 28, 2019

(30) Foreign Application Priority Data
Jun. 5, 2018 (DE) 20 2018 103 133.3

(51) Int. Cl. B60H 1/34

(52) U.S. Cl. CPC B60H 1/3421; B60H 2001/3492

(57) ABSTRACT

An interior component of a vehicle includes a basic body (10) on which there is arranged a decorative element (14) which is produced in an extrusion process and which has a different surface nature than the basic body (10).

### TECHNICAL FIELD

The invention relates to an interior component of a vehicle, comprising a basic body.

### BACKGROUND

Such interior components are installed in the interior of a vehicle, such as a passenger car or truck. By way of example, there may be mentioned air vents and their air guiding elements, such as air guiding slats.

On the one hand, interior components must withstand not inconsiderable loading during operation. This applies particularly to manually actuated or moved interior components. On the other hand, there exist ever higher requirements in terms of the surface quality and design versatility of the interior components. For this purpose, it is known, for example, to produce the interior components in an injection molding process from a high gloss material or to subsequently chrome plate a basic body of an interior component. However, chrome electroplating, due to the use of chromium VI in the chrome plating process, is problematic for health and environmental protection reasons and in the meantime also on account of legal requirements. Moreover, chrome plating is associated with relatively high costs. Interior components created in a known manner also offer only a limited design freedom.

EP 1 655 160 B1 and DE 10 2013 107 173 A1 disclose air guiding slats of air vents in which a further element, for example a coated decorative element, is connected to a basic body of the air guiding slat. According to EP 1 655 160 B1, the further element can be a varnished injection molded part. According to DE 10 2013 107 173 A1, the decorative element can be chrome plated. The production of these known interior components is complicated and has the aforementioned disadvantages, particularly with respect to the chrome plating.

Further air guiding slats are known from DE 20 2012 102 333 U1 and DE 20 2012 102 840 U1. The air guiding slat known from DE 20 2012 102 840 U1 is provided with a coating of polyurethane. However, the design freedom achieved thereby is small. The air guiding slat known from DE 20 2012 102 333 U1 is formed as an extruded hollow profile made of metal or plastic, at least two tubular through openings formed by a longitudinal rib being provided in the longitudinal direction, and a retaining attachment made of metal or plastic on a functional element being able to be inserted in a self-retaining manner into at least one through opening in at least one end side of the air guiding slat. The production of this air guiding slat is complicated and it has a small design freedom.

### SUMMARY

Proceeding from the explained prior art, the object on which the invention is based is therefore to provide an interior component of the type stated at the outset which, in combination with simple production, allows an optimally high design freedom while reliably meeting the loadability requirements.

The invention achieves the object by means of the subject matter of independent claim 1. Advantageous embodiments can be found in the dependent claims, the description and the figures.

For an interior component of the type stated at the outset, the invention achieves the object in that a decorative element which is produced in an extrusion process is arranged on the basic body and has a different surface nature than the basic body.

Where mention is made in this application of an extrusion process, this also includes, in principle, a pultrusion process. The interior component is the interior component of a vehicle, such as a passenger car or truck. It is at least partially visible from the vehicle interior. The interior component has a basic body and a decorative element which is visible from the vehicle interior. The basic body can consist of a plastic. The decorative element can likewise consist of a plastic, produced in an extrusion process. However, the decorative element can, for example, also consist of metal or, for example, ceramic, produced by an extrusion process.

Since, according to the invention, a basic body and a decorative element arranged thereon are provided, it is possible, on the one hand, for the requirements placed on the loadability and, on the other hand, for the high requirements in terms of optical and haptic impression and design freedom to be reliably met. The decorative element has a different surface nature than the basic body, with the result that the surface of the decorative element can be particularly adapted to the optical or haptic requirements. Chrome plating is not required. The disadvantages associated therewith are thus avoided. At the same time, the production of the decorative element in an extrusion process is simple and cost-effective. The basic body can be produced in a suitable manner, with the result that it is also possible here to select a cost effective and simple process, for example. A multiplicity of different optical and haptic appearance forms can be realized for a predetermined basic body by means of different decorative elements. There results a wide variety of decorative and technical possibilities from which it is possible to choose in a flexible manner. For example, for a change of the optical appearance of the decorative element, no additional investment for production tools, for example, is required. The extrusion process allows a simple and cost effective production precisely for elongate components without complicated geometries. Since the decorative element can be produced separately from the basic body, it can be configured in a targeted manner without complicated geometries. By contrast, the basic body can, as already explained, be produced in another way, with the result that even complicated geometries can be fashioned here without problem.

The basic body and the decorative element can particularly consist of different materials. For example, the basic body can consist of a material particularly adapted in terms of the loading to be expected, such as a reinforced plastic, in particular a glass fiber reinforced plastic. By contrast, the decorative element can consist of a less loadable material, for example a nonreinforced plastic. There may be mentioned purely by way of example PA(6) glass fiber reinforced plastic for the basic body and PA(6) nonreinforced plastic for the decorative element.

The decorative element can have a different color and/or a different gloss and/or a different roughness than the basic body. The decorative element can have, for example, a higher gloss and/or a lower roughness. In this way, the visible surface formed by the decorative element can be designed to be more high grade than the basic body.

According to a further embodiment, the surface of the decorative element can be formed at least in certain portions by a layer which is applied after the extrusion process and which is preferably applied by lamination or by means of coextrusion. The layer can be, for example, a film or foil, for example a plastic film. In the course of an extrusion process, there frequently occur extrusion striae and other surface disturbances. These can be reliably concealed by this embodiment, resulting in a high grade surface of the decorative element. The layer allows a flexible color and pattern configuration. For example, films or foils with a high-gloss, metal or wood appearance are also conceivable as the layer. Laborious varnishing is not required. However, varnishing of the decorative element would also be conceivable in principle, particularly since varnishing of the decorative element would also be particularly simple on account of its possibly simple geometry. For example, the laborious covering of functional regions of the slat could thus be dispensed with. Layers, for example color layers (print, for example transfer print), applied by means of different methods constitute further decoration possibilities.

According to a further embodiment, the decorative element can be held on the basic body by latching. This results in particularly simple mounting. For this purpose, the decorative element can have latching elements which latch with corresponding latching elements of the basic body. It is also conceivable that the decorative element is held on the basic body by adhesive bonding or welding.

According to a further embodiment, the decorative element can, particularly completely, enclose the basic body over its circumference. For example, the decorative element can be a hollow profile which encloses the basic body completely, for example. In this embodiment, the decorative element can be pushed onto the basic body, in particular in the longitudinal direction. The entire circumferential surface of the interior component can be formed by the decorative element. According to a further embodiment in this respect, the decorative element can be an elastic shell element having a latching connection formed on opposite longitudinal edges of the shell element. The elastic shell element particularly forms an open hollow profile, for example with a C shaped cross section, the open longitudinal edges of the hollow profile being able to be closed by locking the latching connection. The elastic shell element can then be placed on the basic body, for example by elastic widening of the receiving region formed between the opposite longitudinal edges. By closing the latching connection formed on the longitudinal edges, the decorative element can then again enclose the basic body. Here, it is possible again for the entire circumferential surface of the interior component to be formed by the decorative element. Alternatively or additionally to a latching connection, it would also be conceivable to adhesively bond or to weld the open longitudinal edges of the shell element. It would also be conceivable for the shell element to latch on the basic body by its latching connection. In the mounted state, the open longitudinal edges of the shell element particularly face away from the vehicle interior, with the result that they are not visible to vehicle occupants. The decorative element can be adapted to the shape of the basic body. For example, the decorative element can be hollow cylindrical. It can have, for example, a substantially oval cross sectional shape.

In the aforementioned embodiments, the decorative element can particularly be attached to the basic body in such a way that it can be moved or pivoted together therewith.

According to a further embodiment, there can also be provision that the decorative element is pivotably connected to the basic body such that the decorative element is not concomitantly pivoted during a pivoting movement of the basic body. The pivotable connection can be realized, for example, by a latching connection. In this embodiment, the decorative element is held movably on the basic body. Here, the decorative element can be latched on the front edge, for example of an air guiding slat, in such a way that the decorative element has an axis of rotation with the air guiding slat that is identical to the axis of rotation of the air guiding slat with respect to the housing. It is thus possible to connect the decorative element rigidly as a (decorative) cover which covers the housing. The decorative element can be, for example, a central web of such a cover. The decorative element thus forms the visible front edge of the air guiding slat. If the air guiding slat is pivoted, the visible front edge remains at the same location. A styling requirement is thereby met whereby the appearance of the vent should not change even with the air guiding slats pivoted. It is particularly the case here that the visible front edge of the air guiding slat can project considerably beyond the axis of rotation without changing its position during pivoting.

According to a particularly practical embodiment, the basic body can be produced in an injection molding process. Injection molding processes allow even complicated geometries to be fashioned in a simple manner. A combination of extrusion (of the decorative element), lamination (of the decorative element), injection molding (of the basic body) and cutting to size (cutting the extruded profile to length) is thus possible overall according to the invention.

According to a further embodiment, the interior component and the decorative element can be of elongate design, in particular having a ratio of length to thickness of at least 3:1, preferably of at least 5:1. In the case of a thickness which is irregular over the length or of a non-rotationally symmetrical cross section, the number values refer to the ratio of the length to the greatest thickness. As already explained, the extrusion process is particularly well suited for elongate objects. Of course, other ratios of the length to thickness are also conceivable, for example if the decorative element is a decorative element of a slide button of an air vent.

The interior component can be an air guiding element, in particular an air guiding slat, of an air vent. The invention also relates to an air vent having at least one air guiding element according to the invention, in particular an air guiding slat according to the invention, as interior component according to the invention. The air vent can have a housing with an inlet opening and an outlet opening between which there is formed an air duct for fresh air to be channeled from the vehicle surroundings into the vehicle interior. One or more air guiding elements according to the invention can then be adjustably arranged in the air duct and, in particular, one or more air guiding slats according to the invention can be arranged pivotably in said air duct. The air can thus be deflected into the vehicle interior in a desired manner. In the aforementioned embodiment, the decorative element can form a cover for the air guiding slat. In particular, the decorative element can form a front edge of the air guiding slat that faces the vehicle interior. For this purpose, the decorative element can have a U shaped cross section, for example. However, other components also come into consideration as interior components, for example operator control elements, such as operator control buttons, of an air vent, housing parts of air vents and adjoining parts, for example decorative strips or the like. Grids or grilles of air vents or the like also come into consideration as interior component according to the invention.

The invention also achieves the object by a method for producing an interior component according to the invention, in particular an interior component as claimed in one of the claims, in which the basic body is produced, in which the decorative element is produced in an extrusion process, and in which the decorative element is arranged on the basic body. As explained, the basic body can be produced in an injection molding process, for example. The decorative element produced in the extrusion process can then be arranged on the basic body. The surface of the decorative element can be covered, in particular laminated, at least in certain portions with a layer, such as a film, foil or the like, as likewise explained.

### BRIEF DESCRIPTION OF THE DRAWINGS

Exemplary embodiments of the invention will be explained in more detail below with reference to figures, in which schematically:

FIG. 1 shows an interior component according to the invention according to a first exemplary embodiment in a perspective view,

FIG. 2 shows an enlarged detail of the interior component shown in FIG. 1,

FIG. 3 shows the interior component from FIG. 1 in a premounted state in a perspective view,

FIG. 4 shows an interior component according to the invention according to a second exemplary embodiment in a perspective view,

FIG. 5 shows an enlarged detail of the interior component shown in FIG. 4,

FIG. 6 shows the interior component from FIG. 4 in a premounted state in a perspective view,

FIG. 7 shows an interior component according to the invention according to a third exemplary embodiment in a perspective view,

FIG. 8 shows the interior component from FIG. 7 in a premounted state in a perspective view,

FIG. 9 shows an interior component according to the invention according to a third exemplary embodiment in a perspective view,

FIG. 10 shows a sectional view of the interior component from FIG. 9 in a first operating position,

FIG. 11 shows the sectional view from FIG. 10 in a second operating position, and

FIG. 12 shows the interior component from FIG. 9 in a further perspective partial view.

Unless stated otherwise, identical reference signs designate identical objects in the figures.

### DETAILED DESCRIPTION

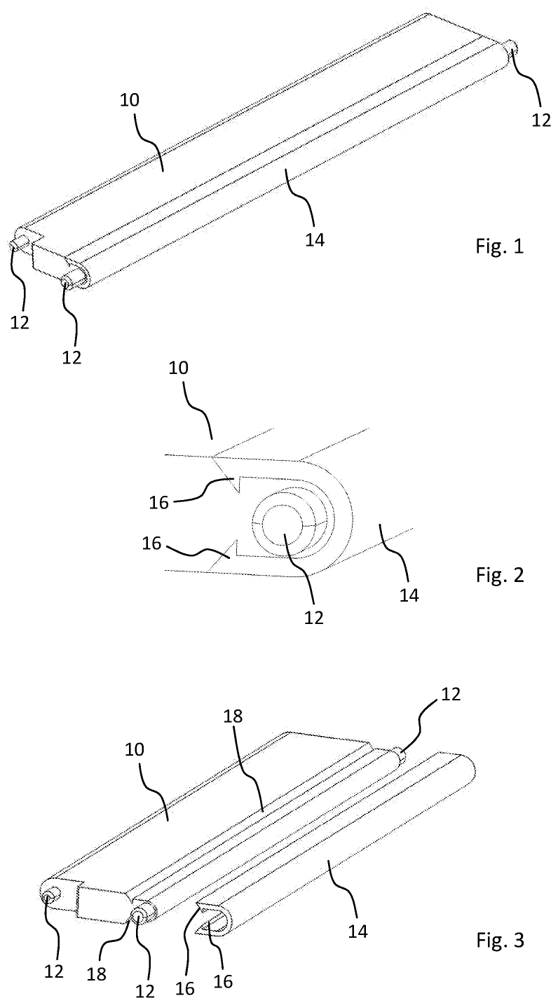

The interior component according to the invention that is shown in FIG. 1 is an air guiding slat of an air vent for a vehicle, such as a passenger car or truck. The air guiding slat has a basic body 10 on whose opposite end sides there are formed bearing journals 12 via which the air guiding slat is pivotably mounted on a housing of the air vent. The basic body 10 consists of a plastic, produced in the present case in a plastic injection molding process. For example, it can be a glass fiber reinforced plastic. The basic body 10 has an elongate shape and its ratio of length to thickness is at least 3:1.

Arranged on the basic body 10 in the example illustrated is a decorative element 14 produced in an extrusion process. The decorative element 14 has a U shaped cross section and, in the illustrated example, completely covers the front edge of the basic body 10 that faces the vehicle interior in the mounted state. The decorative element 14 likewise consists of a plastic, in the present case for example a different plastic than the basic body 10. For example, the decorative element 14 can consist of a nonreinforced plastic. In the example shown, the outer side of the U shaped profile of the decorative element 14 has been laminated with a film or foil, in the present case a plastic film, after the extrusion process.

On the free ends of the legs of the U profile of the decorative element 14, the latter has inwardly directed, cross sectionally triangular latching projections 16. Corresponding, cross sectionally triangular latching receptacles 18, which can be seen in particular in FIG. 3, are formed on the upper side and the lower side of the basic body 10. If the decorative element 14 is pushed onto the basic body 10 starting from the premounted state shown in FIG. 3, the latching projections 16 correspondingly latch in the latching receptacles 18.

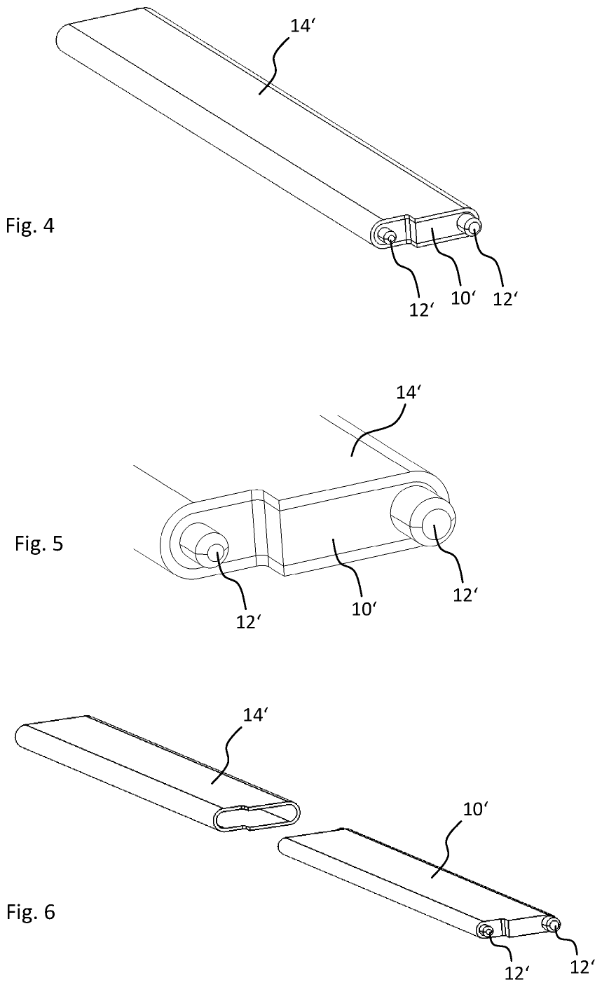

FIG. 4 shows an air guiding slat according to the invention according to a second exemplary embodiment. It likewise has an elongate basic body 10′ on whose end sides there are again formed bearing journals 12′ for pivotably mounting in a housing of an air vent. The basic body 10′ can consist, for example, of the same material as the basic body 10 of the air guiding slat shown in FIG. 1 or of another material.

In the exemplary embodiment shown in FIGS. 4 to 6, the decorative element 14′ is formed as a hollow profile which encloses the basic body 10′. The decorative element 14′ has an oval cross section. It can again consist of the same material as the decorative element 14 of the air guiding slat shown in FIG. 1 or of another material. The decorative element 14′ of the air guiding slat shown in FIG. 4 has also been produced in an extrusion process. The decorative element 14′ can again be provided with a layer applied after the extrusion process, in particular a film or foil, for example a plastic film, applied by lamination. The layer or the film or foil can, for example, cover the entire circumferential surface of the decorative element 14′. For mounting, the decorative element 14′ adapted to the shape of the basic body 10′ is pushed onto the basic body 10′ in the longitudinal direction starting from the premounted state shown in FIG. 6. It can be held on the basic body 10′ by a slight press fit, for example.

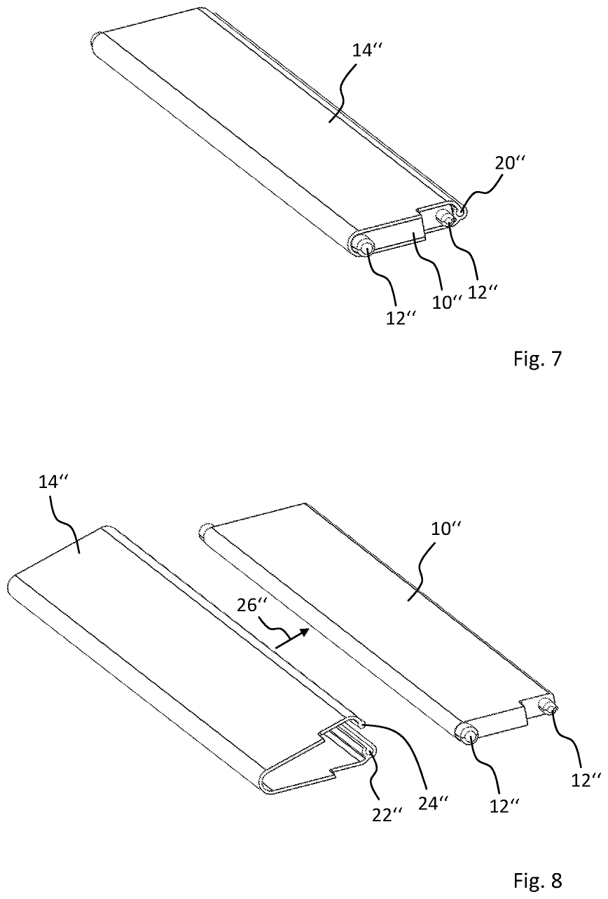

FIGS. 7 and 8 show an air guiding slat according to the invention according to a third exemplary embodiment. It likewise has an elongate basic body 10″ on whose end sides there are again formed bearing journals 12″ for pivotably mounting in a housing of an air vent. The basic body 10″ can consist, for example, of the same material as the basic body 10 of the air guiding slat shown in FIG. 1 or of another material.

In the exemplary embodiment shown in FIGS. 7 and 8, the decorative element 14″ is formed as an elastic shell element. The elastic shell element forms an open hollow profile. It has a latching connection 20″ on opposite longitudinal edges which delimit a receptacle. For this purpose, as can be seen particularly in FIG. 8, one of the longitudinal edges has a cross sectionally C-shaped latching receptacle 22″ and the opposite longitudinal edge has a corresponding latching projection 24″. For mounting, the decorative element 14″ can be placed on the basic body 10″, as illustrated in FIG. 8 by the arrow 26″. The latching connection 20″ formed by the latching projection 24″ and the latching receptacle 22″ can then be locked, with the result that the decorative element 14″ encloses the basic body 10″.

The decorative element 14″ can again consist of the same material as the decorative element 14 of the air guiding slat shown in FIG. 1 or of another material. The decorative element 14″ of the air guiding slat shown in FIG. 7 has also been produced in an extrusion process. The decorative element 14″ can again be provided with a layer, in particular a film or foil applied by lamination, for example a plastic film, applied after the extrusion process. The layer or the film or foil can cover, for example, the entire circumferential surface of the decorative element 14″. The decorative element 14″ from FIGS. 7 and 8 can also be held on the basic body 10″ by a slight press fit, for example.

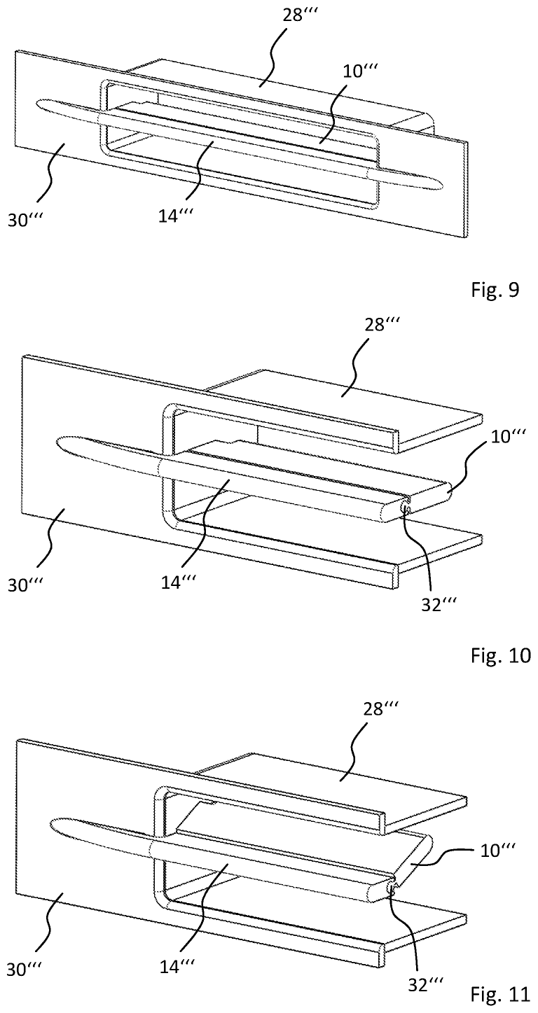

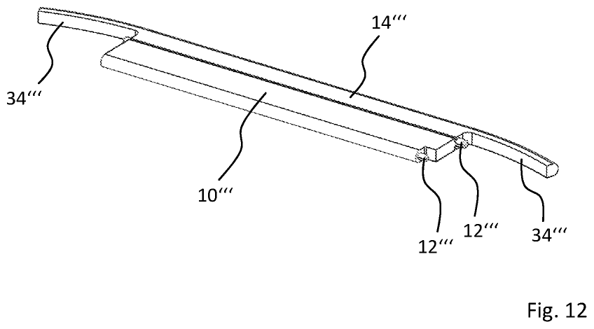

FIGS. 9 and 12 show an air guiding slat according to the invention according to a third exemplary embodiment, partially in the state in which it is installed in a housing 28′″ of an air vent. The air guiding slat shown in FIGS. 9 to 12 likewise has an elongate basic body 10′″ on whose end sides there are again formed bearing journals 12′″ for pivotably mounting in the housing 28′″ of the air vent. The housing additionally has a cover 30′″ whose central web is formed in the present case by the decorative element 14′″. The decorative element 14′″ can be formed separately from the cover 30′″ and be mounted thereon. The basic body 10′″ can consist of the same material as or a different material than the basic body 10 of the air guiding slat shown in FIG. 1.

In the exemplary embodiment shown in FIGS. 9 to 12, the basic body 10′″ of the air guiding slat has a latching projection 32′″ which is received in a corresponding C shaped latching receptacle of the decorative element 14′″. As a result, the decorative element 14′″ is pivotably connected to the basic body 10′″. A pivoting movement of the basic body 10′″ is thus possible without the decorative element 14′″ being concomitantly pivoted, as can be seen from a comparison of FIGS. 10 and 11. Here, the decorative element 14′″ does not change its position. The latching projection 32′″ can be situated coaxially to the pivot axis of the associated bearing pin 12′″.

It can be seen in the partial view of FIG. 12 that the decorative element 14′″ has cut sections 34′″ on its rear side in order that the decorative element 14′″ can be guided around the bearing point of the air-guiding slat 10′″ and be inserted into the cover. The cut sections 34′″ create a sufficient clearance and elastic deformability of the decorative element 14′″. The decorative element 14′″ is thus braced and held between the air guiding slat 10′″, the housing 28′″ and the cover 30′″. Additional fastenings between the decorative element 14′″ and the cover 30′″ are conceivable, for example in the form of hot caulking, adhesive bonding, clipping or the like.

### LIST OF REFERENCE SIGNS

10 Basic body
10′ Basic body
10″ Basic body
10′″ Basic body
12 Bearing journal
12′ Bearing journal
12″ Bearing journal
12′″ Bearing journal
14 Decorative element
14′ Decorative element
14″ Decorative element
14′″ Decorative element
16 Latching projections
18 Latching receptacles
20″ Latching connection
22″ Latching receptacle
24″ Latching projection
26″ Arrow
28′″ Housing
30′″ Cover
32′″ Latching projection
34′″ Cut section

What is claimed is:

1. An interior component of a vehicle, comprising a basic body (10, 10′, 10″, 10′″), characterized in that a decorative element (14, 14′, 14″, 14′″) which is produced in an extrusion process is arranged on the basic body (10, 10′, 10″, 10′″) and has a different surface nature than the basic body (10, 10′, 10″, 10″).

2. The interior component as claimed in claim 1, characterized in that the decorative element (14, 14′, 14″, 14′″) has a different colour and/or a different gloss and/or a different roughness than the basic body (10, 10′, 10″, 10′″).

3. The interior component as claimed in claim 1, characterized in that the surface of the decorative element (14, 14′, 14″, 14′″) is formed at least in certain portions by a layer which is applied after the extrusion process and which is preferably applied by lamination or by means of coextrusion.

4. The interior component as claimed in claim 1, characterized in that the decorative element (14, 14′, 14″, 14′″) is held on the basic body (10, 10′, 10″, 10′″) by latching.

5. The interior component as claimed in claim 1, characterized in that the decorative element (14, 14′, 14″, 14′″) is held on the basic body (10, 10′, 10″, 10′″) by adhesive bonding or welding.

6. The interior component as claimed in claim 1, characterized in that the decorative element (14, 14′, 14″, 14′″) encloses the basic body.

7. The interior component as claimed in claim 6, characterized in that the decorative element (14, 14′, 14″, 14′″) is a hollow profile which encloses the basic body (10, 10′, 10″, 10′″).

8. The interior component as claimed in claim 6, characterized in that the decorative element (14, 14′, 14″, 14′″) is an elastic shell element having a latching connection (20″) formed on opposite longitudinal edges of the shell element.

9. The interior component as claimed in claim 1, characterized in that the decorative element (14, 14′, 14″, 14′″) is pivotably connected to the basic body (10, 10′, 10″, 10′″) such that the decorative element (14, 14′, 14″, 14′″) is not concomitantly pivoted during a pivoting movement of the basic body (10, 10′, 10″, 10′″).

10. The interior component as claimed in claim 1, characterized in that the basic body (10, 10′, 10″, 10′″) is produced in an injection-molding process.

11. The interior component as claimed in claim 1, characterized in that the interior component and the decorative element (14, 14′, 14″, 14′″) are of elongate design, in particular having a ratio of length to thickness of at least 3:1.

12. The interior component as claimed in claim 1, characterized in that the interior component is an air-guiding slat, of an air vent.

13. The interior component as claimed in claim 1, characterized in that the interior component is a slide button or a cover.

14. An interior component of a vehicle, comprising:
a basic body (10, 10′, 10″, 10′″) having a decorative element (14, 14′, 14″, 14′″), which is produced in an extrusion process and which is positioned on the basic body (10, 10′, 10″, 10′″), wherein the decorative element has at least one of:
a surface colour that is different than a surface colour of the basic body,
and/or
a surface gloss that is different than a surface gloss of the basic body,
and/or
a surface roughness that is different than a surface roughness of the basic body.
